(19) United States
(12) Patent Application Publication
(10) Pub. No.: US 2026/0267720 A1
(43) Pub. Date: Sep. 10, 2026

(54) DIAGNOSTIC DEVICE, DIAGNOSIS METHOD, AND DIAGNOSTIC PROGRAM

(71) Applicant: Yokogawa Electric Corporation, Tokyo (JP)

(72) Inventor: Masaru NAKAGAWA, Tokyo (JP)

(21) Appl. No.: 19/165,910

(22) PCT Filed: Feb. 26, 2024
(86) PCT No.: PCT/JP2024/006690

§ 371 Date: Sep. 16, 2025

(30) Foreign Application Priority Data
Mar. 23, 2023 (JP) 2023-046989

(51) Int. Cl. G06F 11/07

(52) U.S. Cl. CPC G06F 11/0736; G06F 11/079; G06F 11/0793

(57) ABSTRACT

A diagnostic device includes a processor configured to identify, based on a diagnostic database that manages, in an associated manner, operation history, trouble factor, and a trouble countermeasure of a reference field instrument and based on operation history of a diagnostic target field instrument, trouble factor and a trouble countermeasure of the diagnostic target field instrument.

### TECHNICAL FIELD

The present invention relates to a diagnostic device, a diagnosis method, and a diagnostic program.

### BACKGROUND ART

It is known that, in a field instrument, an operation for setting, adjusting, and the like of parameters, and an operation for recording an operation history are performed (for example, see NPL 1).

### CITATION LIST

### Patent Literature

NPL 1: Japanese Laid-open Patent Publication No. 2005-70936

### SUMMARY OF INVENTION

### Technical Problem

In the case where a trouble occurs in a field instrument, there is a need to identify trouble factor and a trouble countermeasure. Conventionally, work of reproduction test and data analysis are performed by referring to a past case example of a trouble by an engineer who has expert knowledge. Since time is needed for the work, there is a problem in that it is difficult to take a prompt trouble countermeasure.

An aspect of an embodiment of the present disclosure enables a prompt trouble countermeasure.

### Solution to Problem

A diagnostic device, according to one aspect of the present disclosure, includes a diagnostic unit that identifies, based on a diagnostic database that manages, in an as-sociated manner, operation history, trouble factor, and a trouble countermeasure of a reference field instrument and based on operation history of a diagnostic target field instrument, trouble factor and a trouble countermeasure of the diagnostic target field instrument.

A diagnosis method, according to one aspect of the present disclosure, includes: identifying, based on a diagnostic database that manages, in an associated manner, operation history, trouble factor, and a trouble countermeasure of a reference field instrument and based on operation history of a diagnostic target field instrument, trouble factor and a trouble countermeasure of the diagnostic target field instrument.

A diagnostic program, according to one aspect of the present disclosure, that causes a computer to execute a process including: identifying, based on a diagnostic database that manages, in an associated manner, operation history, trouble factor, and a trouble countermeasure of a reference field instrument and based on operation history of a diagnostic target field instrument, trouble factor and a trouble countermeasure of the diagnostic target field instrument.

### Advantageous Effects of Invention

According to the present invention, it is possible to take a prompt trouble countermeasure.

### BRIEF DESCRIPTION OF DRAWINGS

FIG. 1 is a diagram illustrating, in outline, a configuration of a diagnostic system according to an embodiment.

FIG. 2 is a diagram illustrating an example of a diagnostic database.

FIG. 3 is a diagram illustrating an example of data on a diagnostic target field instrument.

FIG. 4 is a diagram illustrating an example of data on the diagnostic target field instrument.

FIG. 5 is a flowchart illustrating an example of a process (diagnosis method) performed related to a diagnosis.

FIG. 6 is a diagram illustrating an example of a hardware configuration.

### DESCRIPTION OF EMBODIMENTS

Exemplary embodiments of the present invention are described in detail below with reference to the accompanying drawings. The same components are denoted by the same reference numerals and an overlapping description will be omitted.

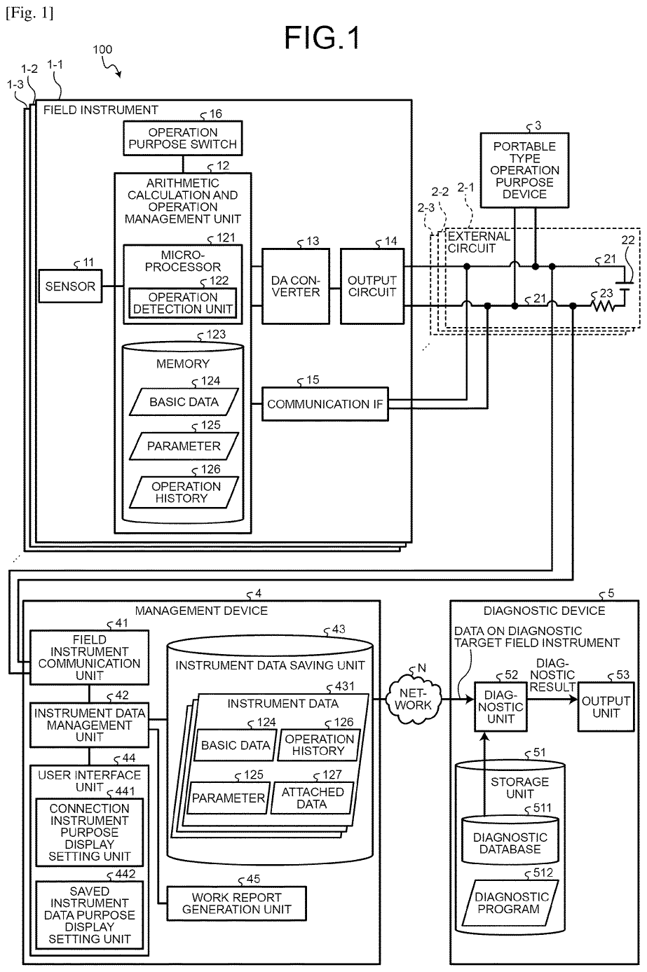

FIG. 1 is a diagram illustrating, in outline, a configuration of a diagnostic system according to an embodiment. A diagnostic system 100 includes a field instrument 1, an external circuit 2, a portable type operation purpose device 3, a management device 4, and a diagnostic device 5.

The field instrument 1 is a measuring instrument that is installed and used in an inside of a field, such as a plant or a factory, and is, more specifically, a transmitter that transmits a signal that indicates the result of the measurement. Examples of the transmitter includes a pressure transmitter, a temperature transmitter, and a flow rate transmitter. A pressure may be interpreted as a meaning including a differential pressure, and a pressure transmitter may be a differential pressure transmitter. The field instrument 1 illustrated in FIG. 1 as an example is a two-wire transmitter and is used by being connected to the external circuit 2.

The plurality of field instruments 1 are present, and, in FIG. 1, the three field instruments 1 are illustrated as an example. To distinguish each of the field instruments 1, the each individual field instrument 1 is referred to as a field instrument 1-1, a field instrument 1-2, and a field instrument 1-3. In a description below, if the field instruments 1-1, 1-2, and 1-3 are not particularly distinguished, the field instruments 1-1, 1-2, and 1-3 are simply referred to as the field instrument 1.

The field instrument 1 includes a sensor 11, an arithmetic calculation and operation management unit 12, a DA converter 13, an output circuit 14, a communication IF 15, and an operation purpose switch 16.

The sensor 11 outputs a sensor value. The sensor value is a voltage value, a current value, or the like that indicates a physical quantity (a pressure, a temperature, a flow rate, etc.) targeted for measurement of a field instrument 1. The sensor 11 is a pressure sensor in the case where the field instrument 1 is a pressure transmitter, and is, more specifically, a pressure reception unit (for example, a diaphragm unit). In the case where the field instrument 1 is a temperature transmitter, the temperature sensor corresponds to the sensor 11, whereas, in the case where the field instrument 1 is a flow rate transmitter, the flow rate sensor corresponds to the sensor 11.

The arithmetic calculation and operation management unit 12 acquires the sensor value that has been output by the sensor 11. The sensor value may be periodically acquired, or may be acquired at an assigned arbitrary timing. In the example illustrated in FIG. 1, the arithmetic calculation and operation management unit 12 is constituted by including a microprocessor 121 and a memory 123. Some processes performed by the microprocessor 121 will be described.

The microprocessor 121 executes an arithmetic calculation (calculation) for converting a sensor value to a measurement value. The measurement value is a physical quantity targeted for the measurement described above, that is, a pressure value, a differential pressure value, a temperature value, a flow rate value, or the like. A method of converting from the sensor value to the measurement value is not particularly limited, but, for example, an algorithm for calculating a measurement value from the sensor value may be used, or a table in which the sensor value is associated with the measurement value may be referred to. The microprocessor 121 generates a digital signal that indicates the measurement value that has been obtained by the arithmetic calculation, and then outputs the generated measurement value to the DA converter 13.

A correction may be added to the arithmetic calculation of the measurement value obtained by the microprocessor 121 described above. One example of a correction is zero adjustment, the measurement value that is obtained by the arithmetic calculation is corrected such that the measurement value in the case where an input to the sensor 11 included in the field instrument 1 becomes zero. A correction amount for setting the measurement value to zero is also referred to as a zero adjustment amount. A needed zero adjustment amount may possibly be changed in accordance with the operating time of the field instrument 1. For example, as the operating time of the field instrument 1 increases, the needed zero adjustment amount also increases.

The microprocessor 121 conducts self-diagnosis on the field instrument 1, that is, more specifically, the microprocessor 121 diagnoses whether the state (instrument state) of the field instrument 1 is a normal state or an abnormal state. For example, if the sensor value or the measurement value is within a predetermined range (within the normal range), the microprocessor 121 diagnoses the state of the field instrument 1 as a normal state, and, if the sensor value or the measurement value is out of the predetermined range (out of the normal range), the microprocessor 121 diagnoses the state of the field instrument 1 as an abnormal state.

The microprocessor 121 manages an operation performed by the field instrument 1. The operation performed by the field instrument 1 includes adjustment of the field instrument 1. The adjustment is made by setting or changing a parameter that defines, for example, an operation work performed by the field instrument 1. One example of the specific adjustment is zero adjustment that has been described above. As will be described later, the operation of the field instrument 1 is performed by using the operation purpose switch 16, the portable type operation purpose device 3, or the management device 4.

The microprocessor 121 manages an operation that has been actually performed on the field instrument 1. A functional block provided by the microprocessor 121 related to the management is referred to as an operation detection unit 122 and is illustrated.

The operation detection unit 122 detects the operation that has been performed with respect to the field instrument 1, and stores the history of the subject operation in the memory 123 as operation history 126. If the operation history 126 that has already been stored is present, the operation history 126 may be updated. The operation history 126 is data in which operation time, operation content, and the like are associated. The operation content includes an operation amount, such as the zero adjustment amount described above. Furthermore, in the present embodiment, it is assumed that the operating time of the field instrument 1 is also included in the operation history 126. The operating time indicates, for example, the time (the length of the period of time) between a time point at which an operation of the field instrument 1 has been started and a time point at which the operation history 126 has been recorded.

The memory 123 stores therein data that is used by the arithmetic calculation and operation management unit 12. Examples of the data stored in the memory 123 include basic data 124, a parameter 125, and the operation history 126. The operation history 126 has been described above, so that the basic data 124 and the parameter 125 will be described.

The basic data 124 is unique data for the field instrument 1. Examples of the basic data 124 include an instrument ID (identifier), an instrument type, an instrument tag name, and a vendor name. The instrument ID is an identifier for uniquely identifying the field instrument 1. The instrument type indicates the type of the field instrument 1 including, for example a pressure transmitter, a temperature transmitter, a flow rate transmitter, or the like. The instrument tag is data that is used to identify the field instrument 1 and that is set such that, for example, a worker is able to easily read the data. The vendor name indicates the vendor of the subject field instrument 1.

The parameter 125 is set to the field instrument 1 and defines, for example, an operation performed by the field instrument 1. Examples of the parameter 125 include a period of the arithmetic calculation or the like of the measurement value (measurement period), a display unit of the measurement value, an instrument state of the field instrument 1 obtained by the self-diagnosis.

The DA converter 13 convers a digital signal (a signal indicating the measurement value) received from the microprocessor 121 to an analog signal, and outputs the converted signal to the output circuit 14.

The output circuit 14 is connected between the output circuit 14 and the external circuit 2. The output circuit 14 convers the analog signal received from the DA converter 13 to a current signal, and performs control such that the current signal flows through the external circuit 2 and the output circuit 14. The current signal appears in the external circuit 2, in accordance with the signal that indicates the measurement value, that is, for example, in accordance with the magnitude of the measurement value, as the current signal in which the current value is changed within the range between 4 mA and 20 mA.

In the following, the external circuit 2 will be described. The external circuit 2 is connected to the associated field instrument 1. The plurality of external circuits 2 that are associated with the plurality of respective field instruments 1 are present and, in FIG. 1, an external circuit 2-1 to an external circuit 2-3 that are associated with the field instrument 1-1 to the field instrument 1-3, respectively, are illustrated as an example. In a description below, if the external circuit 2-1 to the external circuit 2-3 are not particularly distinguished, the external circuit 2-1 to the external circuit 2-3 are simply referred to as the external circuit 2.

The external circuit 2 includes transmission lines 21, a direct-current power source 22, and a resistor 23. The transmission lines 21 are a pair of the transmission lines 21 that are connected to the output circuit 14 that is included in the field instrument 1. The direct-current power source 22 and the resistor 23 are connected in series between the pair of the transmission lines 21.

If the above described current signal flows through the external circuit 2, a voltage (potential difference) with the magnitude that is in accordance with the magnitude of the current signal is generated between the both ends of the resistor 23, that is, between the pair of the transmission lines 21. By detecting the voltage, it is possible to acquire the measurement value that has been obtained by the field instrument 1. In this way, the measurement value obtained by the field instrument 1 is transmitted from the field instrument 1 to the outside.

A description will be given here by referring back to the field instrument 1. The communication IF 15 is a communication interface that is connected to the transmission lines 21 that are included in the external circuit 2. By using the transmission lines 21 included in the external circuit 2 as communication lines, the communication IF 15 communicates with a device that is provided an outside of the field instrument 1, that is, in this example, the portable type operation purpose device 3 and the management device 4.

The operation purpose switch 16 is used to operate the field instrument 1. For example, the operation purpose switch 16 includes various kinds of switches responding to the operation performed on the field instrument 1. As a result of the worker changing the switch, the associated operation is performed on the field instrument 1.

The portable type operation purpose device 3 is also used to operate the field instrument 1. The portable type operation purpose device 3 is connected to the transmission lines 21 included in the external circuit 2 when the portable type operation purpose device 3 is used, and communicates with the communication IF 15 that is included in the field instrument 1. For example, the portable type operation purpose device 3 transmits an operation request (a command for instructing an operation, etc.) to the communication IF 15 included in the field instrument 1. In the field instrument 1, the microprocessor 121 operates the field instrument 1 in accordance with the operation request that has been received by the communication IF 15.

The management device 4 is used to manage the field instrument 1, and an operation of the field instrument 1 is also included in the management of the field instrument 1. The management device 4 includes a field instrument communication unit 41, an instrument data management unit 42, an instrument data saving unit 43, a user interface unit 44, and a written work report generation unit 45.

The field instrument communication unit 41 is connected to the transmission lines 21 that are included in each of the plurality of external circuits 2, and communicates with the communication IF 15 that is included in each of the plurality of field instruments 1 by using the transmission lines 21 as communication lines.

The instrument data management unit 42 performs overall control of the management device 4 by controlling elements other than the management device 4. For example, the instrument data management unit 42 acquires (collects) data related to each of the field instruments 1 by controlling the field instrument communication unit 41. Examples of the acquired data include the basic data 124, the parameter 125, the operation history 126, and the like that are stored in the memory 123 that is included in each of the field instruments 1. Furthermore, the instrument data management unit 42 operates each of the field instruments 1 by controlling the field instrument communication unit 41. Similarly to the portable type operation purpose device 3, the operation may be performed by transmission of the operation request.

The instrument data saving unit 43 is a database that arranges the data related to the field instrument 1 acquired by the instrument data management unit 42 and that stores therein the data as instrument data 431. In the example illustrated in FIG. 1, the instrument data 431 related to each of the field instruments 1 is arranged, and each of the pieces of instrument data 431 associates the basic data 124, the parameter 125, the operation history 126, and attached data 127 that are associated with the field instrument 1. Moreover, the attached data 127 is data (a memorandum, an image, etc.) that has arbitrarily been generated about the associated field instrument 1 by the worker as additional data.

The user interface unit 44 displays the instrument data 431, receives an operation performed by each of the field instruments 1. In the example illustrated in FIG. 1, the user interface unit 44 includes a connection instrument purpose display setting unit 441 and a saved instrument data purpose display setting unit 442. The connection instrument purpose display setting unit 441 displays the data that has been acquired from the field instrument 1 that is being connected (during communication establishment), and receives an operation performed by the connected field instrument 1. The saved instrument data purpose display setting unit 442 displays the instrument data 431 related to the arbitrary field instrument 1 stored in the instrument data saving unit 43, and receives an operation performed by the arbitrary field instrument 1.

The written work report generation unit 45 generates a written work report in which at least some of the instrument data 431 is described in accordance with a predetermined format (template). For example, by generating each of the written work reports about before and after the operation performed on the field instrument 1, it is possible to leave the data that is related to the field instrument 1 and that is located before and after the operation in the form of a written report.

Before the diagnostic device 5 will be described, a problem of the conventional technology will be described. There may be a case in which a trouble occurs in the field instrument 1 (becomes in an abnormal state). Conventionally, an engineer having expert knowledge performs diagnosis work for identifying the trouble factor or work for identifying an appropriate trouble countermeasure. Specifically, the engineer acquires, by using the portable type operation purpose device 3 or the management device 4, the data related to the operation history 126 or the like of the field instrument 1 in which the trouble has occurred, and performs diagnosis work of a reproduction test, data analysis, or the like by referring to the case example or the like of the other field instrument 1 in which a trouble occurred in the past. After the trouble factor or the trouble countermeasure has been identified by way of such diagnosis work, the trouble countermeasure is provided to the user of the field instrument 1. There is a need to spend a lot of time for the diagnosis work, so that there is a problem in that it is difficult to take a prompt trouble countermeasure.

According to the present embodiment, as will be described later, the diagnosis work for the field instrument 1 including work for identifying the trouble factor and the trouble countermeasure is automated by the diagnostic device 5, and as a result of this, a prompt trouble countermeasure becomes possible.

Specifically, the diagnostic device 5 diagnoses the field instrument 1 that is the target for a diagnosis from among the plurality of field instruments 1. The field instrument 1 that is the target for a diagnosis is also referred to as a “diagnostic target field instrument”. Moreover, in the example illustrated in FIG. 1, the diagnostic device 5 is constituted so as to be able to communicate with the management device 4 via a network N. The diagnostic device 5 may be a server device (cloud device) that is arranged at a location away from the field instrument 1 and the management device 4, or may be an on-premises device that is arranged near the field instrument 1 and the management device 4. The diagnostic device 5 includes a storage unit 51, a diagnostic unit 52, and an output unit 53.

The storage unit 51 stores therein the data that is used in the diagnostic device 5. As the data stored in the storage unit 51, a diagnostic database 511 and a diagnostic program 512 may be indicated as an example.

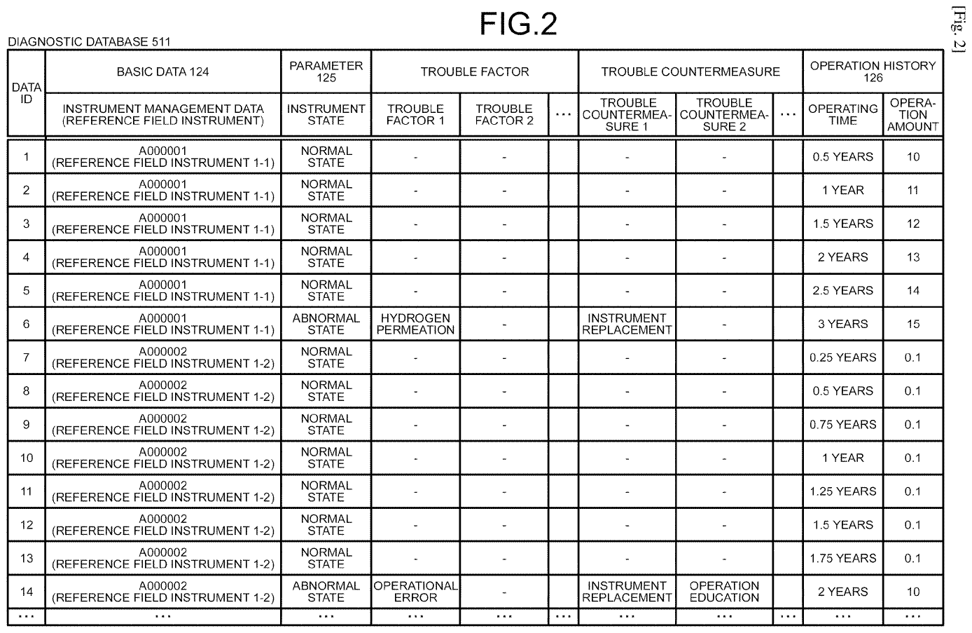

The diagnostic database 511 includes data that is related to the field instrument 1 in which a trouble occurred in the past and the trouble factor and the trouble countermeasure of that trouble have been identified. The field instrument 1 like this is also referred to as a “reference field instrument”. The diagnostic database 511 will be described with reference to FIG. 2.

FIG. 2 is a diagram illustrating an example of the diagnostic database. The diagnostic database 511 manages, in an associated manner, the basic data 124 related to the reference field instrument, the parameter 125, the trouble factor, the trouble countermeasure, and the operation history 126. In this example, the field instrument 1-1 and the field instrument 1-2 are the “reference field instruments”, and, in the following, the field instrument 1-1 and the field instrument 1-2 may also be referred to as a reference field instrument 1-1 and a reference field instrument 1-2.

The data ID is an identifier for uniquely identifying the data. In FIGS. 2, 14 pieces of data associated with the data ID of 1 to 14 are illustrated as an example.

The basic data 124 is used as an instrument management data that uniquely identifies the field instrument 1. For example, the instrument ID that is included in the basic data 124 or a combination of the instrument type and the instrument tag name may possibly be the instrument management data. In FIG. 1, the instrument management data on the reference field instrument 1-1 is schematically illustrated as instrument management data A000001. The instrument management data on the reference field instrument 1-2 is schematically illustrated as instrument management data A000002.

The parameter 125 is, more specifically, here, an instrument state. In this example, the instrument state of the reference field instrument 1-1 is a normal state in the data ID indicated by 1 to 5, and is an abnormal state in the data ID indicated by 6. The instrument state of the reference field instrument 1-2 is a normal state in the data ID indicated by 7 to 13, and is an abnormal state in the data ID indicated by 14.

The trouble factor is the factor for the trouble that has occurred in each of the reference field instrument 1-1 and the reference field instrument 1-2, and is, in other words, the factor of the cause of the abnormal state of the reference field instruments 1-1 and 1-2. A plurality of trouble factors may be present with respect to a single abnormal state, and are described as a trouble factor 1, a trouble factor 2, and the like.

In this example, in the data ID indicated by 6, the trouble factor 1 is indicated as hydrogen permeation. The hydrogen permeation is an osmotic phenomenon that occurs in a pressure reception unit (for example, a metallic diaphragm unit) included in a pressure transmitter and in which hydrogen ion penetrates into an enclosed liquid. This phenomenon occurs caused by hydrogen that is included in a fluid and results in a measurement error.

In the data ID indicated by 14, the trouble factor 1 is indicated as an operational error. The operational error is an error occurring at the time of an operation performed on the field instrument 1 by the worker. Examples of the operational error include a state in which adjustment order of the reference field instrument 1-2 has been mistaken, a state in which too much pressure has been applied, and the like.

The trouble countermeasure is countermeasure performed on the reference field instrument 1-1 and the reference field instrument 1-2, and is, in other words, a countermeasure for returning the reference field instruments 1-1 and 1-2 to the normal state. A plurality of trouble countermeasures may be performed on a single abnormal state, and the trouble countermeasure is separately described as a trouble countermeasure 1, a trouble countermeasure 2, and the like.

In this example, in the data ID indicated by 6, the trouble countermeasure 1 is indicated as an instrument replacement. The instrument replacement indicates that, as it is named, the reference field instrument 1-1 has been replaced.

In the data ID indicated by 14, the trouble countermeasure 1 is indicated as an instrument replacement, and the trouble countermeasure 2 is indicated as operation education. The operation education indicates that education (training) related to an operation has been conducted to the worker who made an operational error, in order to prevent a repetition of the trouble caused by the same operational error.

The operation history 126 is, more specifically, here, the operating time and an operation amount. The operating time of the reference field instrument 1-1 increases in the order of the data IDs of 1 to 6. The operating time of the reference field instrument 1-2 increases in the order of the data IDs of 7 to 14. The operation amount is, for example, the zero adjustment amount or the like as described above, and the numerical value of operation amount is schematically indicated. In this example, the operation amount of the reference field instrument 1-1 gradually increases as the operating time increases. The operation amount of the reference field instrument 1-2 is not changed even if the operating time becomes long, but the operation amount of the reference field instrument 1-2 sharply increases caused by the operational error.

For example, the diagnostic database 511 is generated in advance and is stored in the storage unit 51. A specific order of the procedures for generating the diagnostic database 511 is not particularly limited, and, for example, work performed by the worker, the engineer, or the like of the field instrument 1 may be present between the procedures.

A description will be given here by referring back to FIG. 1. The diagnostic program 512 stored in the storage unit 51 is a program (software and an application program) that causes a computer to function as the diagnostic device 5.

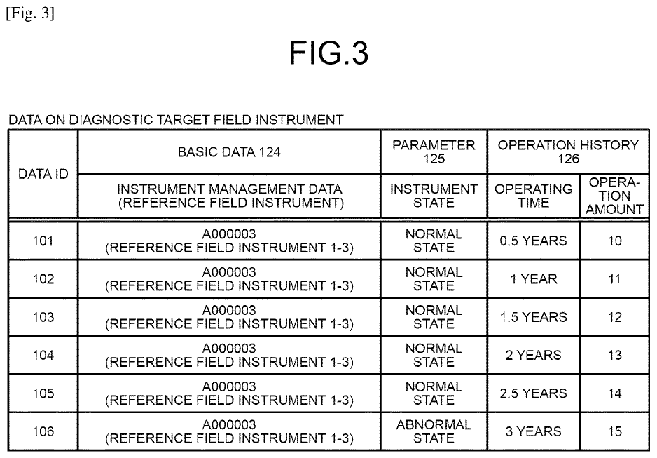

The diagnostic unit 52 diagnoses the diagnostic target field instrument on the basis of the diagnostic database 511 and the data related to the diagnostic target field instrument. The data related to the diagnostic target field instrument will be described by also referring to FIG. 3.

FIG. 3 is a diagram illustrating an example of the data related to the diagnostic target field instrument. The data is data in which the data ID of the diagnostic target field instrument, the basic data 124 (more specifically, the instrument management data), the parameter 125 (more specifically, the instrument state), and the operation history 126 (more specifically, the operating time and the operation amount) are associated with each other. In this example, the field instrument 1-3 is a “diagnostic target field instrument”, and, in the following description, the field instrument 1-3 is also referred to as a diagnostic target field instrument 1-3. The instrument state of the diagnostic target field instrument 1-3 is a normal state in the data ID indicated by 101 to 105, and is an abnormal state in the data ID indicated by 106.

For example, the data related to the diagnostic target field instrument 1-3 as described above is acquired from the management device 4.

A description will be given here by referring back to FIG. 1. The diagnostic unit 52 diagnoses the diagnostic target field instrument 1-3 on the basis of the diagnostic database 511 and the data (the operation history 126, etc.) that is related to the diagnostic target field instrument 1-3. The diagnosis includes identification of the trouble factor and the trouble countermeasure of the diagnostic target field instrument 1-3.

First, the diagnostic unit 52 searches the diagnostic database 511 for the reference field instrument (for example, the reference field instrument 1-1 or the reference field instrument 1-2) that has the operation history 126 that has a similarity to the operation history 126 of the diagnostic target field instrument. The similarity may be interpreted as a meaning including a likeness.

One example of the similarity is a similarity of a temporal change of the operation amount (for example, the zero adjustment amount). The diagnostic unit 52 in this case searches the diagnostic database 511 for the reference field instrument that has a temporal change in an operation amount that has a similarity to a temporal change in the operation amount of the diagnostic target field instrument 1-3.

For example, the diagnostic unit 52 calculates a temporal change in the operation amount from the operating time and the operation amount of the diagnostic target field instrument 1-3, and generates data on the change in the operation amount indicating the calculation result. The data on the change in the operation amount may also referred to as data obtained by differentiating the operation amount with respect to the operating time (discretize and differentiate). Similarly, the diagnostic unit 52 generates, from the operating time and the operation amount of each of the reference field instruments that are included in the diagnostic database 511, data on a change in the operation amount of each of the reference field instruments. Then, the diagnostic unit 52 searches the diagnostic database 511 for the reference field instrument having the data on the change in the operation amount that has a similarity to the data on the change in the operation amount related to the diagnostic target field instrument 1-3. Various kinds of known methods may be used for a method of determining the similarity.

In the example described above with reference to FIG. 2 and FIG. 3, the operation history 126 of the diagnostic target field instrument 1-3 and the operation history 126 of the reference field instrument 1-1 are similar with each other. The diagnostic unit 52 searches the diagnostic database 511 and detects the reference field instrument 1-2. Then, the diagnostic unit 52 identifies the trouble factor and the trouble countermeasure of the reference field instrument 1-1, that is, the hydrogen permeation and the instrument replacement, as the trouble factor and the trouble countermeasure of the diagnostic target field instrument 1-3.

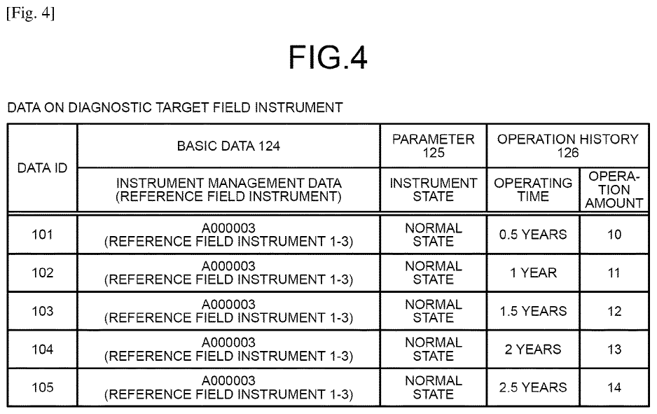

In one embodiment, regarding the diagnostic target field instrument 1-3 in which a trouble has not yet been occurred, the diagnostic unit 52 diagnoses a tendency of occurrence or non-occurrence of the trouble. In this case, the diagnostic unit 52 may identify the trouble factor and the trouble countermeasure about the trouble that is likely to be generated in the diagnostic target field instrument 1-3 in the future. One example will be described with reference to FIG. 4.

FIG. 4 is a diagram illustrating an example of data on the diagnostic target field instrument. When compared with FIG. 3, FIG. 4 is different from FIG. 3 in that data with the data ID indicated by 106 is not included. The instrument state of the diagnostic target field instrument 1-3 is a normal state, and no trouble has occurred.

Even in this case, the operation history 126 of the diagnostic target field instrument 1-3 and the operation history 126 of the reference field instrument 1-1 are similar with each other (FIG. 2), so that the diagnostic unit 52 searches the diagnostic database 511 and detects the reference field instrument 1-1. Then, the diagnostic unit 52 estimates that, as the trouble factor, a trouble, that is, a trouble caused by the hydrogen permeation, of the reference field instrument 1-1 will occur in the diagnostic target field instrument 1-3. Furthermore, the trouble countermeasure of the reference field instrument 1-1, that is, the instrument replacement, is identified as the trouble countermeasure of the diagnostic target field instrument 1-3.

A description will be given here by referring back to FIG. 1. The diagnostic unit 52 generates the data indicating the diagnostic result of the diagnostic target field instrument 1-3. The diagnostic result includes the identified operation history 126 (the operating time, the operation amount, etc.) the trouble factor, and the trouble countermeasure of the diagnostic target field instrument 1-3. In addition to this, the basic data 124, the parameter 125, the attached data 127, and the like of the diagnostic target field instrument 1-3 may also be included in the diagnostic result.

The output unit 53 outputs the diagnostic result that has been generated by the diagnostic unit 52. For example, the output unit 53 is constituted by a display, a data output port, and the like, and displays the diagnostic result and outputs the data. As a result of the diagnostic result being output, the diagnostic result is notified to the person involved, for example, a user, a worker, an engineer, or the like of the field instrument 1.

For example, in this way as described above, a diagnosis of the diagnostic target field instrument 1-3 including identification of the trouble factor and the trouble countermeasure of the diagnostic target field instrument 1-3 is performed, and the diagnostic result thereof is output. The diagnostic device 5 automatically diagnoses the diagnostic target field instrument 1-3, so that an engineer having expert knowledge does not always need to perform work of analysis or the like by taking the time. Even in the case in which frequency of the analysis is reduced or even in the case in which analysis is conducted, it is possible to reduce the length of the analysis. As a result of this, it is possible to take a prompt trouble countermeasure. In the case where the diagnostic unit 52 diagnoses a tendency of occurrence or non-occurrence of a trouble of the diagnostic target field instrument 1-3 before the occurrence of a trouble, the diagnostic result thereof is output, so that it is also possible to avoid the trouble beforehand.

The timing of the diagnosis performed by the diagnostic unit 52 is not limited. For example, the diagnostic unit 52 may monitors the instrument state of each of the field instruments 1 by accessing the instrument data 431 that is included in the instrument data saving unit 43 included in the management device 4, and may identify the field instrument 1 in which the instrument state is an abnormal state (a trouble has occurred) as the diagnostic target field instrument. A diagnosis is performed immediately after the trouble has been detected. If the field instrument 1 in which the instrument state is a normal state (no trouble has occurred) is also included as a selection target, it is possible to appropriately diagnose to be performed in order to avoid a trouble beforehand. Of course, a worker, an engineer, or the like may also operate the diagnostic device 5 and manually select the diagnostic target field instrument.

It may also be possible to update the diagnostic database 511 by effectively using the diagnostic result. For example, the diagnostic unit 52 may add the diagnosed diagnostic target field instrument 1-3, that is, the diagnostic target field instrument 1-3 in which the trouble factor and the trouble countermeasure have been identified, to the diagnostic database 511 as a new reference field instrument. The specific data to be added is the data illustrated in FIG. 2 as described above. By accumulating a larger number of pieces of data related to the reference field instrument into the diagnostic database 511, it is possible to put the accumulated data to use to improve the accuracy of the diagnosis to be performed on another diagnostic target field instrument next time and from then onward.

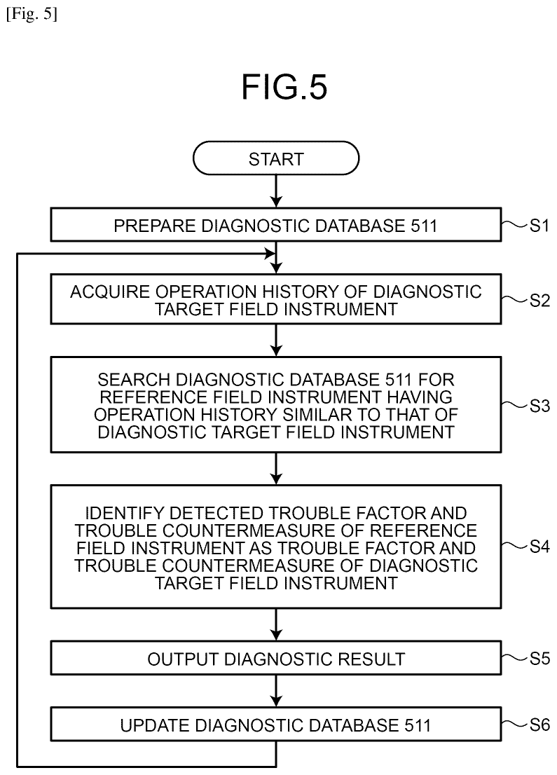

FIG. 5 is a flowchart illustrating an example of a process (diagnosis method) performed related to the diagnosis. Descriptions of the content overlapped with the above described content will be appropriately omitted.

At Step S1, the diagnostic database 511 is prepared. The diagnostic database 511 is stored in the storage unit 51 that is included in the diagnostic device 5.

At Step S2, the diagnostic unit 52 included in the diagnostic device 5 acquires the operation history of the diagnostic target field instrument. For example, the operation history 126 that is related to the diagnostic target field instrument 1-3 and that is included in the instrument data 431 that is stored in the instrument data saving unit 43 included in the management device 4 is acquired. The basic data 124 and the parameter 125 of the diagnostic target field instrument 1-3 may also be acquired.

At Step S3, the diagnostic unit 52 included in the diagnostic device 5 searches the diagnostic database 511 for the reference field instrument having the operation history that has a similarity to the operation history of the diagnostic target field instrument. For example, the reference field instrument 1-1 having the operation history that has a similarity to the operation history 126 of the diagnostic target field instrument 1-3 is detected by the search.

At Step S4, the diagnostic unit 52 included in the diagnostic device 5 identifies the detected trouble factor and the trouble countermeasure of the reference field instrument as the trouble factor and the trouble countermeasure of the diagnostic target field instrument. For example, the trouble factor and the trouble countermeasure, that is the hydrogen permeation and the instrument replacement, of the reference field instrument 1-1 is identified as the trouble factor and the trouble countermeasure of the diagnostic target field instrument 1-3.

At Step S5, the output unit 53 of the diagnostic device 5 outputs the diagnostic result. The diagnostic result including the trouble factor and the trouble countermeasure that have been identified at previous Step S4 is displayed or the like.

At Step S6, the diagnostic unit 52 included in the diagnostic device 5 updates the diagnostic database 511. For example, the diagnostic target field instrument 1-3 in which the trouble factor and the trouble countermeasure have been identified at previous Step S4 is added to the diagnostic database 511 as the new reference field instrument. After that, the process returns to Step S2.

After the process at Step S6 has been completed, the process returns to Step S2. By repeatedly performing the processes at Step S2 to Step S6, a diagnosis of the diagnosis target field instrument, in which the trouble has actually occurred, or a diagnosis of the diagnostic target field instrument, in which a trouble tends to occur even before occurrence of a trouble, is appropriately and automatically performed, and then, the diagnostic result thereof is obtained.

### Modification

The disclosed technology is not limited to the above described embodiment. For example, the operation amount is not limited to the zero adjustment amount. Any operation amount having a correlation with the trouble of the field instrument 1 may be used. By accumulating data related to various operation amounts into the diagnostic database 511, it is possible to cope with a large variety of troubles.

All of the data related to the field instrument 1, for example, all of the data on the basic data 124, the parameter 125, and the operation history 126 (and also the attached data 127), may be stored in the diagnostic database 511. By using the past data on a measurement target, a use environment, a case example of a trouble, a trouble countermeasure, and the like, related to the model type of the field instrument 1, it is possible to suggest the data as specification determinant factor of the instrument at the time of a new purchase to the user. For example, there is a possibility of occurrence of a trouble caused by the hydrogen permeation, it is possible to suggest a pressure transmitter having a pressure reception unit coated with gold in order to make the hydrogen permeation less likely to occur, instead of using a pressure reception unit (a diaphragm unit) coated with a normal metal film.

### Example of Hardware Configuration

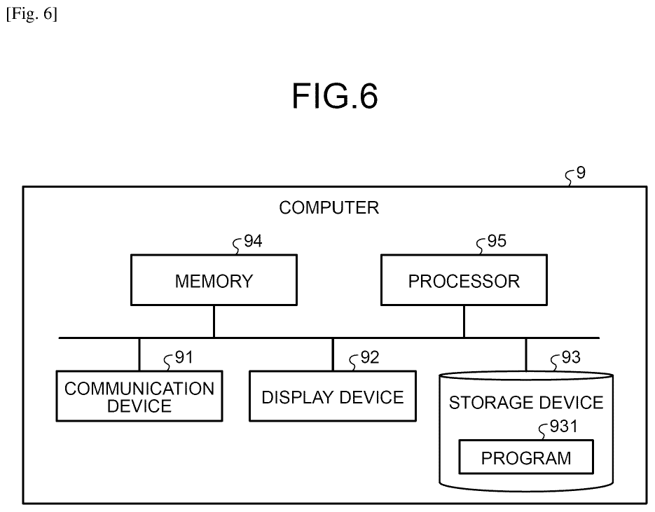

FIG. 6 is a diagram illustrating an example of a hardware configuration. A device or the like constituted by a computer 9 illustrated as an example functions as the field instrument 1, the portable type operation purpose device 3, the management device 4, or the diagnostic device 5 that are described above. As the hardware configuration of the computer 9, a communication device 91, a display device 92, a storage device 93, a memory 94, and a processor 95 that are connected by a bus or the like with each other are exemplified.

The communication device 91 is a network interface card or the like, and enables to communicate with another device. The communication device 91 may correspond to, for example, the communication IF 15, the field instrument communication unit 41, or the like described above. The display device 92 may correspond to, for example, the output unit 53, or the like described above.

The storage device 93 and the memory 94 stores therein various kinds of data. A specific example of the storage device 93 is a hard disk drive (HDD), a read only memory (ROM), a random access memory (RAM), or the like. The memory 94 may also be a part of the storage device 93. As the data stored in the storage device 93, a program 931 is exemplified. The program 931 is a program (software) that causes the computer 9 to function as the field instrument 1, the portable type operation purpose device 3, the management device 4, or the diagnostic device 5. One example of the program 931 is the diagnostic program 512 that has been described above, and causes the computer 9 to execute the process performed by the diagnostic unit 52.

The processor 95 executes various kinds of processes. For example, the processor 95 causes the computer 9 to execute the various kinds of processes performed in the field instrument 1, the portable type operation purpose device 3, the management device 4, or the diagnostic device 5 by reading (reading out) the program 931 from the storage device 93 and lording the read program 931 in the memory 94.

The program 931 may be collectively or separately distributed via a network, such as the Internet. Furthermore, the program 931 may be executed by collectively or separately storing the program 931 in a recording medium that can be read by a computer readable recording medium, such as a hard disk, flexible disk (FD), a CD-ROM, a magneto-optical disk (MO), a digital versatile disk (DVD), or the like, and read the program 931 from the recording medium by the computer 9.

The technology described above is specified, for example, as follows. One of the disclosed technology is the diagnostic device 5. As described above with reference to FIG. 1 to FIG. 4 or the like, the diagnostic device 5 includes the diagnostic unit 52 that identifies the trouble factor and the trouble countermeasure of the diagnostic target field instrument 1-3 on the basis of the diagnostic database 511 that manages, in an as-sociated manner, the operation history 126, the trouble factor, and the trouble countermeasure of the reference field instrument 1-1, the reference field instrument 1-2, and the like and on the basis of the operation history 126 of the diagnostic target field instrument 1-3. According to the diagnostic device 5, it is possible to automatically diagnose the diagnostic target field instrument 1-3 including identification of the trouble factor and the trouble countermeasure of the diagnostic target field instrument 1-3 by effectively using the diagnostic database 511. Accordingly, this makes it possible to take a prompt trouble countermeasure.

The diagnostic unit 52 may search the diagnostic database 511 for the reference field instrument 1-1 having the operation history 126 that has a similarity to the operation history 126 of the diagnostic target field instrument 1-3, and may identify the trouble factor and the trouble countermeasure (for example, the hydrogen permeation and the instrument replacement) that have been detected by the search and that is related to the reference field instrument 1-1 as the trouble factor and the trouble countermeasure of the diagnostic target field instrument 1-3. The operation history 126 may include an operation amount (for example, the zero adjustment amount), and the similarity may also include a similarity of the temporal change in the operation amount. For example, it is possible to identify the trouble factor and the trouble countermeasure of the diagnostic target field instrument 1-3 by effectively using the diagnostic database 511 as well as the similarity search performed as described above.

The diagnostic unit 52 may identify the trouble factor and the trouble countermeasure of the trouble that may possibly occur in the diagnostic target field instrument 1-3 in the future. As a result of this, it is possible to avoid a trouble possibly occurring in the diagnostic target field instrument 1-3 beforehand.

The diagnostic unit 52 may add the diagnostic target field instrument 1-3 in which the trouble factor and the trouble countermeasure have been identified as a new reference field instrument to the diagnostic database 511. It is possible to accumulate a larger number of pieces of data related to the reference field instrument into the diagnostic database 511, and it is possible to put the accumulated data to use to improve the accuracy of the diagnosis to be performed on another diagnostic target field instrument next time and from then onward.

The diagnostic device 5 may include the output unit 53 that outputs the diagnostic result that includes the trouble factor and the trouble countermeasure of the diagnostic target field instrument 1-3 identified by the diagnostic unit 52. By notifying the person involved of the diagnostic result, this makes it possible to contribute to prompt a trouble countermeasure.

The diagnosis method described above with reference to FIG. 1 to FIG. 5 and the like is also one of the disclosed technologies. The diagnosis method includes a method of identifying the trouble factor and the trouble countermeasure of the diagnostic target field instrument 1-3 (Step S2 to Step S4) on the basis of the diagnostic database 511 and the operation history 126 of the diagnostic target field instrument 1-3. Even with the diagnosis method, as described above, it is possible to take a prompt trouble countermeasure.

The diagnostic program 512 described above with reference to FIG. 1 to FIG. 6 and the like is also one of the disclosed technologies. The diagnostic program 512 causes the computer 9 to execute the process (Step S2 to Step S4) of identifying the trouble factor and the trouble countermeasure of the diagnostic target field instrument 1-3 on the basis of the diagnostic database 511 and the operation history 126 of the diagnostic target field instrument 1-3. Even with the diagnostic program 512, as described above, it is possible to take a prompt trouble countermeasure. A computer readable recording medium having stored therein the diagnostic program 512 is also one of the disclosed technologies.

Some examples of combinations of the disclosed technical features are described in the following.
(1)

A diagnostic device comprising a diagnostic unit that identifies, based on a diagnostic database that manages, in an associated manner, operation history, trouble factor, and a trouble countermeasure of a reference field instrument and based on operation history of a diagnostic target field instrument, trouble factor and a trouble countermeasure of the diagnostic target field instrument.
(2)

The diagnostic device according to (1), wherein
the diagnostic unit
   searches the diagnostic database for the reference field instrument having the operation history that has a similarity to the operation history of the diagnostic target field instrument, and
   identifies the trouble factor and the trouble countermeasure of the reference field instrument that has been detected by the search as the trouble factor and the trouble countermeasure of the diagnostic target field instrument.
(3)

The diagnostic device according to (2), wherein
the operation history includes an operation amount, and
the similarity includes a similarity of a temporal change in the operation amount.
(4)

The diagnostic device according to (3), wherein the operation amount includes a zero adjustment amount.
(5)

The diagnostic device according to any one of (1) to (4), wherein the diagnostic unit identifies the trouble factor and the trouble countermeasure about a trouble that is likely to occur in the diagnostic target field instrument in the future.
(6)

The diagnostic device according to any one of (1) to (5), wherein the diagnostic unit adds the diagnostic target field instrument, in which the trouble factor and the trouble countermeasure have been identified, to the diagnostic database as a new reference field instrument.
(7)

The diagnostic device according to any one of (1) to (6), further comprising an output unit that outputs a diagnostic result including the trouble factor and the trouble countermeasure that is related to the diagnostic target field instrument and that has been identified by the diagnostic unit.
(8)

A diagnosis method comprising:
identifying, based on a diagnostic database that manages, in an associated manner, operation history, trouble factor, and a trouble countermeasure of a reference field instrument and based on operation history of a diagnostic target field instrument, trouble factor and a trouble countermeasure of the diagnostic target field instrument.
(9)

A diagnostic program that causes a computer to execute a process comprising:
identifying, based on a diagnostic database that manages, in an associated manner, operation history, trouble factor, and a trouble countermeasure of a reference field instrument and based on operation history of a diagnostic target field instrument, trouble factor and a trouble countermeasure of the diagnostic target field instrument.

### REFERENCE SIGNS LIST

100 diagnostic system
1 field instrument
1-1 reference field instrument
1-2 reference field instrument
1-3 diagnostic target field instrument
11 sensor
12 arithmetic calculation and operation management unit
121 microprocessor
122 operation detection unit
123 memory
124 basic data
125 parameter
126 operation history
127 attached data
13 DA converter
14 output circuit
15 communication IF
16 operation purpose switch
2 external circuit
21 transmission line
22 direct-current power source
23 resistor
3 portable type operation purpose device
4 management device
41 field instrument communication unit
42 instrument data management unit
43 instrument data saving unit
431 instrument data
44 user interface unit
441 connection instrument purpose display setting unit
442 saved instrument data purpose display setting unit
45 written work report generation unit
5 diagnostic device
51 storage unit
511 diagnostic database
512 diagnostic program
52 diagnostic unit
53 output unit
9 computer
91 communication device
92 display device
93 storage device
931 program
94 memory
95 processor
N network

1. A diagnostic device comprising a processor configured to identify, based on a diagnostic database that manages, in an associated manner, operation history, trouble factor, and a trouble countermeasure of a reference field instrument and based on operation history of a diagnostic target field instrument, trouble factor and a trouble countermeasure of the diagnostic target field instrument.

2. The diagnostic device according to claim 1, wherein
the processor is configured to
searches search the diagnostic database for the reference field instrument having the operation history that has a similarity to the operation history of the diagnostic target field instrument, and
identify the trouble factor and the trouble countermeasure of the reference field instrument that has been detected by the search as the trouble factor and the trouble countermeasure of the diagnostic target field instrument.

3. The diagnostic device according to claim 2, wherein
the operation history includes an operation amount, and
the similarity includes a similarity of a temporal change in the operation amount.

4. The diagnostic device according to claim 3, wherein the operation amount includes a zero adjustment amount.

5. The diagnostic device according to claim 1, wherein the diagnostic unit identifies the trouble factor and the trouble countermeasure about a trouble that is likely to occur in the diagnostic target field instrument in the future.

6. The diagnostic device according to claim 1, wherein the processor is configured to e add the diagnostic target field instrument, in which the trouble factor and the trouble countermeasure have been identified, to the diagnostic database as a new reference field instrument.

7. The diagnostic device according to claim 1, the processor is configured to output a diagnostic result including the trouble factor and the trouble countermeasure that is related to the diagnostic target field instrument and that has been identified.

8. A diagnosis method comprising:
identifying, based on a diagnostic database that manages, in an associated manner, operation history, trouble factor, and a trouble countermeasure of a reference field instrument and based on operation history of a diagnostic target field instrument, trouble factor and a trouble countermeasure of the diagnostic target field instrument.

9. A non-transitory computer-readable recording medium storing therein a diagnostic program that causes a computer to execute a process comprising:
identifying, based on a diagnostic database that manages, in an associated manner, operation history, trouble factor, and a trouble countermeasure of a reference field instrument and based on operation history of a diagnostic target field instrument, trouble factor and a trouble countermeasure of the diagnostic target field instrument.
